(19) United States
(12) Patent Application Publication
(10) Pub. No.: US 2026/0168209 A1
(43) Pub. Date: Jun. 18, 2026

(54) CONSTRUCTION MACHINE AND CONTROL METHOD THEREOF

(71) Applicant: HD HYUNDAI INFRACORE CO., LTD., Incheon (KR)

(72) Inventors: Sunghoon LEE, Seoul (KR); Yoonkyu YOO, Incheon (KR); Wonsun SOHN, Seoul (KR); Wooyong JUNG, Seoul (KR)

(21) Appl. No.: 18/853,798

(22) PCT Filed: Apr. 4, 2023
(86) PCT No.: PCT/KR2023/004518

§ 371 Date: Oct. 3, 2024

(30) Foreign Application Priority Data
Apr. 4, 2022 (KR) 10-2022-0041601

(51) Int. Cl. E02F 9/22; E02F 9/20; F02D 29/04; F04B 49/06

(52) U.S. Cl. CPC E02F 9/2246; E02F 9/2235; E02F 9/2296; F02D 29/04; F04B 49/06; E02F 9/2004; F02D 2200/04; F02D 2200/101

(57) ABSTRACT

Embodiments of the present disclosure relate to a construction machine and a control method thereof. The construction machine includes an engine that generates power, a pump driven by the engine, an engine control unit that detects an intake air volume of the engine, a joystick that transmits an operation signal, and a vehicle control unit that receives the intake air volume detected by the engine control unit when the operation signal is received from the joystick, and that upwardly changes an increase rate of a pump torque of the pump when the intake air volume is at a certain level.

### TECHNICAL FIELD

An embodiment of the present disclosure relates to a construction machine and a control method thereof, and more particularly, relates to a construction machine and a control method thereof in which a pump is operated by changing a slope of a pump torque of the pump in accordance with an intake air pressure of an engine.

### BACKGROUND ART

In general, construction machines carry out outdoor excavation work. A pump torque of a pump installed in the construction machines is controlled by dynamic characteristics according to an engine speed.

In order to satisfy a smoke reference value of the engine, initial dynamic characteristics of the engine are set to be low. Accordingly, a slope of the pump torque of the pump is set to be low, thereby causing a problem in that an operator feels a slow responsiveness when a work machine is initially operated.

In addition, when the work machine is initially operated, the operator may feel that equipment has no power due to the low slope of the pump torque. Consequently, there is a problem in that productivity of the work using the construction machine is degraded due to a pump operation when the work machine is initially operated.

### DETAILED DESCRIPTION OF INVENTION

### Technical Problems

An embodiment of the present disclosure provides a construction machine and a control method thereof, which can improve a responsiveness of a work machine by changing a slope of a pump torque to operate a pump.

### Technical Solution

According to an embodiment of the present disclosure, there is provided a construction machine including an engine that generates power, a pump driven by the engine, an engine control unit that detects an intake air volume of the engine, a joystick that transmits an operation signal, and a vehicle control unit that receives the intake air volume detected by the engine control unit when the operation signal is transmitted from the joystick, and that upwardly changes an increase rate of a pump torque when the intake air volume is at a certain level.

In addition, the increase rate of the pump torque may be upwardly changed so that a maintenance period of a slope of an initial rising section increases, based on the intake air volume.

In addition, the engine control unit may detect rotation speed information of the engine, and may transmit the rotation speed information to the vehicle control unit, and the vehicle control unit may change a rising slope of the pump torque after the initial rising section, based on the rotation speed information of the engine.

In addition, the engine control unit may detect rotation speed information of the engine, and may transmit the rotation speed information to the vehicle control unit, and the vehicle control unit may upwardly change the increase rate of the pump torque, based on the rotation speed information of the engine.

In addition, the construction machine may further include a pump pressure detection member that detects a pressure of the pump. The vehicle control unit may calculate the pump torque, based on a current discharge flow rate and the pressure of the pump.

In addition, the construction machine may further include a swash plate detection member that detects swash plate information of the pump. The vehicle control unit may calculate the current discharge flow rate of the pump, based on the rotation speed information of the engine and the swash plate information.

In addition, the vehicle control unit may have a slope map in which an inflection point of a slope of the pump torque is set, and the inflection point may be changed in accordance with information on the intake air volume.

In addition, according to another embodiment of the present disclosure, there is provided a construction machine including an engine that generates power, a pump driven by the engine, an engine control unit that detects information on an intake air volume of the engine and a rotation speed of the engine, a joystick that operates a work machine, and a vehicle control unit that determines a continuous operation of the construction machine, based on the information on the intake air volume of the engine, when an operation signal is transmitted from the joystick, and that upwardly changes an increase rate of a pump torque of the pump, based on the intake air volume and a rotation speed of the engine.

In addition, the increase rate of the pump torque may be upwardly changed so that a maintenance period of a slope of an initial rising section increases, based on the intake air volume.

In addition, according to still another embodiment of the present disclosure, there is provided a control method of a construction machine including a vehicle control unit for controlling a pump driven by an engine. The control method includes a step of receiving an operation signal of a joystick, a step of receiving intake air pressure information of the engine and rotation speed information of the engine, and a step of controlling the pump by changing a slope of a pump torque having an inflection point according to a preset rotation speed of the engine to an inflection point of the slope of the pump torque mapped based on the intake air pressure information of the engine.

In addition, the control method may further include a step of receiving the rotation speed information of the engine and pressure information of the pump, calculating a current discharge flow rate of the pump, and calculating the pump torque, based on the calculated current discharge flow rate of the pump and the received pressure information of the pump.

In addition, the control method may further include a step of determining a continuous operation of a work machine, when the intake air pressure information exceeds a preset range after an operation signal of the joystick is received.

### Effect of Invention

According to an embodiment of the present disclosure, a construction machine and a control method thereof can improve a responsiveness of a work machine by adjusting a slope of a pump torque. Specifically, the construction machine can effectively control a pump while satisfying smoke conditions of an engine by adjusting a change rate of the pump torque, based on intake air pressure information.

### BRIEF DESCRIPTION OF THE DRAWING

FIG. 1 illustrates a configuration diagram of a construction machine according to an embodiment of the present disclosure.

FIG. 2 illustrates an engine and intake air supplied thereto according to the embodiment of the present disclosure.

FIG. 3 illustrates a current pump torque of a pump according to a rotation speed of the engine of the present disclosure.

FIG. 4 illustrates a slope of the pump torque of the pump which is stored in the construction machine of the present disclosure.

FIG. 5 illustrates a pump torque rising slope according to intake air volume information of the present disclosure.

FIG. 6 illustrates a state where the slope of the pump torque is changed when the intake air volume information of the present disclosure is high.

FIG. 7 illustrates the slope of the pump torque when the intake air volume information of the present disclosure is low.

FIG. 8(a) and 8(b) illustrate a change rate of the pump torque with the lapse of time, a change of an engine torque, and a change rate of a rotation speed of the engine at this time.

FIG. 9(a) and 9(b) illustrate a change rate of the pump torque, a change rate of the engine torque, and a change rate of a cylinder speed at this time.

FIG. 10(a) to 10(c) illustrate formation of a boost pressure and a behavior of an available torque of the engine according to a user's operation in a general construction machine.

FIG. 11(a) and 11(b) illustrate the general construction machine in an upper drawing, and the construction machine of the present disclosure in a lower drawing.

FIGS. 12 and 13 illustrate a control process of the construction machine according to another embodiment of the present disclosure.

### BEST MODE FOR CARRYING OUT THE INVENTION

Hereinafter, with reference to the accompanying drawings, embodiments of the present disclosure will be described in detail so that a person having ordinary skill in the art to which the present disclosure pertains can easily embody the present disclosure. The present disclosure may be implemented in various different forms, and is not limited to the embodiments described herein.

It is noted that the drawings are schematically provided and are not illustrated in accordance with actual scales. Relative dimensions and proportions of portions in the drawings are exaggerated or reduced in size for clarity and convenience in the drawings. Any dimension is provided as an example, and does not include a limitation. In addition, the same reference numerals are used to indicate similar characteristics for the same structural elements or components appearing in two or more drawings.

The embodiments of the present disclosure specifically show ideal embodiments of the present disclosure. As a result, various modifications in the drawings are expected. Therefore, the embodiments are not limited to specific forms of the illustrated regions, and include modifications in manufacturing forms, for example.

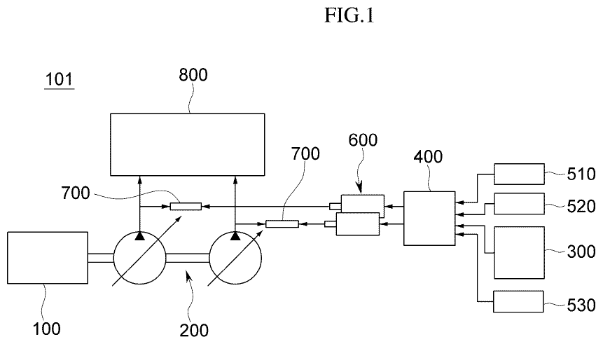

Hereinafter, with reference to FIGS. 1 to 11, a construction machine (101) according to an embodiment of the present disclosure will be described.

As illustrated in FIG. 1, the construction machine (101) includes an engine (100), a pump (200), an engine control unit (300), a joystick (530), and a vehicle control unit (400).

The engine (100) generates power. Specifically, the engine (100) receives fuel and generates the power to provide a driving force for the construction machine (101).

The pump (200) is driven by the engine (100). Specifically, the pump (200) generates a high-pressure oil. Accordingly, a main control valve (800) is controlled by a signal from the joystick (530), and the high-pressure oil is provided to operate a work machine. The pump (200) may be an electronic pump.

The engine control unit (300) detects information of the engine (100). In addition, the engine control unit (300) detects information on an intake air volume supplied for combustion of the engine (100). Specifically, the engine control unit (300) may be installed in the engine (100) to detect the information of the engine (100).

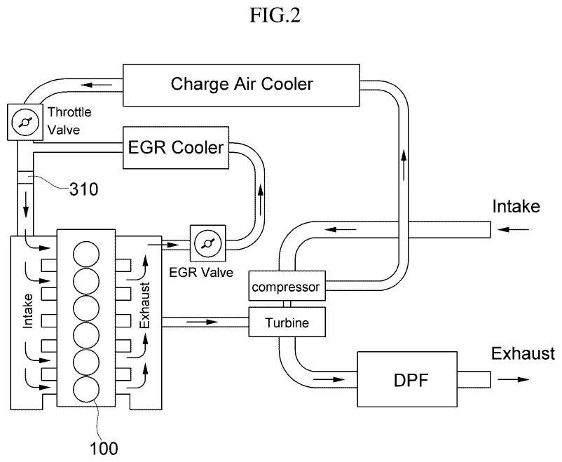

Specifically, as illustrated in FIG. 2, with regard to the information on the intake air volume, the amount of air flowing into an intake port of the engine (100) is detected by a booster sensor (310), and is calculated as the information of the intake air volume. That is, the engine control unit (300) receives information of the booster sensor (310). That is, the engine control unit (300) may determine a fuel amount limit value (torque) from the amount of the air suctioned into the engine (100).

As an example, the information on the intake air volume may be intake air pressure information or boost pressure information.

The joystick (530) transmits an operation signal for operating the construction machine (101). Specifically, the joystick (530) may be operated by an operator to transmit the operation signal for operating the construction machine (101) to components for operating the construction machine (101).

The vehicle control unit (400) receives the operation signal of the joystick (530). In addition, the vehicle control unit (400) receives the information on the intake air volume detected by the engine control unit (300). The vehicle control unit (400) receives the operation signal from the joystick (530), and controls the pump (200) to upwardly change an increase rate of a pump torque of the pump when the information on the intake air volume detected by the engine control unit (300) is at a certain level.

Accordingly, the construction machine (101) according to the embodiment of the present disclosure may control the pump (200) by adjusting a slope of the pump torque, based on the information on the intake air volume currently supplied to the engine (100) and the operation signal of the joystick (530). That is, the construction machine (101) according to the embodiment of the present disclosure may improve a responsiveness of the work machine by setting the slope of the pump torque output by the pump (200), based on the information on the intake air volume corresponding to a current load of the engine (100).

According to the embodiment of the present disclosure, the vehicle control unit (400) may control the pump (200) so that a maintenance period of a slope of an initial rising section increases, based on the intake air amount detected by the engine control unit (300) when the increase rate of the pump torque is upwardly changed.

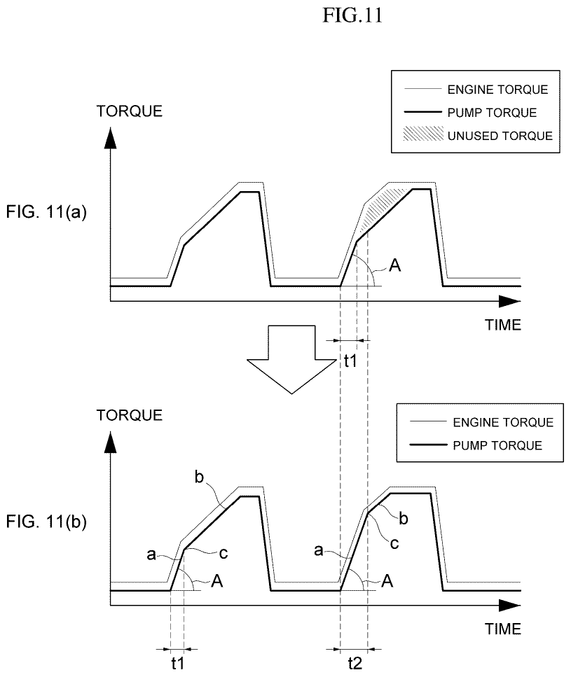

As illustrated in FIG. 11(a) and 11(b), when the vehicle control unit (400) receives the operation signal of the joystick (530) and determines that the intake air volume detected by the engine control unit (300) is at a certain level, the vehicle control unit (400) may control the pump (200) so that a maintenance period increases for a steep slope (A) of the initial rising section of the pump torque with the lapse of time.

Specifically, when the vehicle control unit (400) determines that the intake air volume is at the certain level, the steep slope (A) of the initial rising section of the pump torque may be maintained for a relatively longer time, compared to when the operation signal of the joystick (530) is not received or when the vehicle control unit (400) determines that the intake air volume is not at the certain level.

That is, as illustrated in FIG. 11(a) and 11(b), the pump torque includes an initial rising section (first rising section: a) and a second rising section (second rising section: b) after an inflection point (c) in time-dependent rising sections. Specifically, a slope of the initial rising section and a slope of the second rising section of the pump torque are different from each other, and the slope of the initial rising section has a relatively greater value than the slope of the second rising section.

The vehicle control unit (400) may increase a maintenance time (t2) of the initial rising section having a steep slope (A) when it is determined that the intake air volume is at the certain level, and may delay a time of the inflection point (c) between the initial rising section and the second rising section of the pump torque.

In this case, a magnitude of the pump torque at the inflection point (c) may have a relatively greater value, compared to when the operation signal of the joystick (530) is received and it is determined that the intake air volume is not at the certain level. That is, the inflection point (c) may be raised.

Therefore, the vehicle control unit (400) may increase the maintenance time (t2) of the steep slope (A) of the initial rising section of the pump torque, compared to a steep slope (t1) in the related art, and may reduce a separation region between an engine torque and the pump torque, compared to a gap region in the related art, as illustrated in FIG. 11(a) and 11(b).

In addition, the engine control unit (300) according to the embodiment of the present disclosure may further detect rotation speed information of the engine (100).

The engine control unit (300) may detect current rotation speed information (rotation RPM of the engine (100)) of the engine (100), and may transmit the current rotation speed information to the vehicle control unit (400).

In addition, the vehicle control unit (400) according to the embodiment of the present disclosure may change a rising slope after the initial rise section of the pump torque, based on the rotation speed information of the engine (100) which is detected by the engine control unit (300).

As illustrated in FIG. 11(a) and 11(b), the vehicle control unit (400) may change the slope of the second rising section (b) in time-dependent rising sections, based on the rotation speed information of the engine which is detected by the engine control unit. Specifically, the vehicle control unit (400) may change the slope of the second rising section (b) after the initial rising section (a) of the pump torque.

That is, the vehicle control unit (400) may control the pump (200) so that the pump has maximum performance efficiency by changing a time-dependent change rate of the pump torque, based on the intake air volume and the rotation speed information of the engine. Specifically, the pump (200) may be controlled in such a manner that the slope of the second rising section (b) is changed from the inflection point (c) by the vehicle control unit (400).

In addition, the vehicle control unit (400) may change a speed of the rising section of the pump torque of the pump, based on the rotation speed information of the engine (100). In addition, the construction machine (101) according to the embodiment of the present disclosure may further include a swash plate detection member (510).

The swash plate detection member (510) detects swash plate information for controlling a discharge flow rate of the pump (200). In addition, the swash plate detection member (510) transmits the detected swash plate information to the vehicle control unit (400).

The vehicle control unit (400) calculates a current discharge flow rate of the pump (200), based on the rotation speed information of the engine which is detected by the engine control unit (300) and the swash plate information detected by the swash plate detection member (510).

In addition, the construction machine (101) according to the embodiment of the present disclosure may further include a pump pressure detection member (520).

The pump pressure detection member (520) detects a pressure of the pump (200). In addition, the pump pressure detection member (520) transmits the detected information to the vehicle control unit (400).

The vehicle control unit (400) calculates the pump torque, based on the calculated current discharge flow rate of the pump and the pressure of the pump (200) which is detected by the pump pressure detection unit (520).

Specifically, the pump torque calculated by the vehicle control unit (400) may be a maximum torque of the pump which can be output by the pump (200) according to current driving of the engine (100). That is, the calculated pump torque may be the maximum torque of the pump that can be output by the pump (200) under current driving conditions of the engine (100).

In addition, in the vehicle control unit (400) according to the embodiment of the present disclosure, a slope map is preset in which the inflection point of the slope of the pump torque is set. The vehicle control unit (400) may change the inflection point, based on the preset slope map in accordance with the information on the intake air volume.

The vehicle control unit (400) may control the pump (200) by changing and applying the inflection point of the slope of the pump torque according to the information on the intake air volume detected by the engine control unit (300). Specifically, the vehicle control unit (400) may adjust an inflection time point of the slope of the pump torque so that the pump torque reaches the maximum torque of the pump which is calculated based on information on current intake air volume.

That is, the vehicle control unit (400) may control the pump (200) by variably applying the inflection time point of the inflection point of the pump torque in accordance with the slope map of the inflection point of the pump torque according to the preset information on the intake air volume, based on the information on the intake air volume.

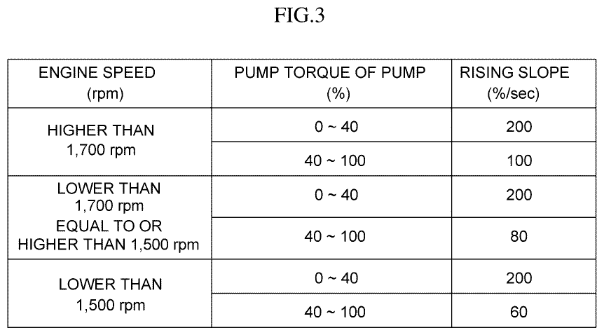

As an example, as illustrated in FIG. 3, information on the slope of the pump torque of the pump (200) according to the rotation speed of the engine (100) is preset in the vehicle control unit (400).

In this case, the rising slope of the maximum pump torque according to the rotation of the engine (100) may be formed to have a first inflection point. Specifically, data in which the slope when the current pump torque of the pump is equal to or lower than 40% of the maximum torque and the slope when the current pump torque of the pump exceeds 40% of the maximum torque according to the rotation of the engine are different from each other may be stored in the vehicle control unit (400). That is, when the current pump torque of the pump is equal to or lower than 40% of the maximum torque of the pump, the slope steeply rises, and when the current pump torque of the pump exceeds 40% of the current pump torque of the pump, compared to the maximum torque of the pump, the slope relatively gently rises.

Specifically, when the rotation speed of the engine is 1,700 rpm and the pump torque is 0% to 40%, a pump torque rising slope may be 200%/s. In addition, when the pump torque is 40% or higher to 100%, the pump torque rising slope may be 100%/s.

In addition, as illustrated in FIG. 3, when the rotation speed of the engine is lower than 1,700 rpm and higher than 1,500 rpm, and when the pump torque is 0% to 40%, the rising slope of the pump torque may be set to 200%/s, and when the pump torque exceeds 40% and reaches 100%, the pump torque rising slope may be set to 80%/s.

When the rotation speed of the engine is lower than 1,500 rpm, and when the pump torque is 0% to 40%, the rising slope of the pump torque may be set to 200%/s, and when the pump torque exceeds 40% and reaches 100%, the pump torque rising slope may be set to 60%/s.

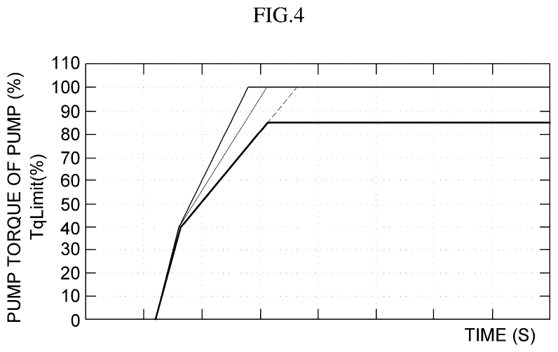

In other words, as illustrated in FIG. 4, through test data, the vehicle control unit (400) stores that the slopes are the same in a certain section of the pump torque of the pump according to the rotation speed of the engine, and the slopes are changed thereafter. That is, the slope of the pump torque having an inflection section is prestored in the vehicle control unit (400).

In this case, when the first inflection point of the current torque of the pump is 40% of the maximum torque of the pump through an experiment of the pump torque rising slope according to the rotation speed of the engine, the first inflection point may be changed by reflecting the pump torque rising slope preset according to the information on the intake air volume when the pump torque rises. That is, the vehicle control unit (400) may control the pump (200) by changing the inflection section of the slope of the pump torque.

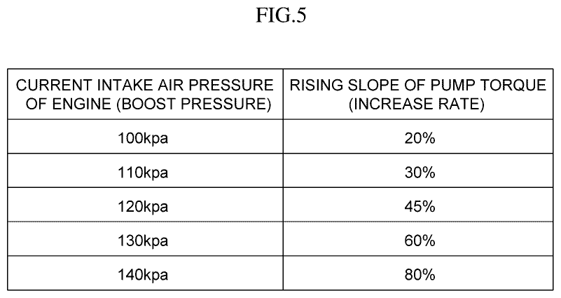

As illustrated in FIG. 5, in the vehicle control unit (400), a slope map is preset in which the inflection point of the rising slope of the pump torque mapped according to the current intake air volume is set.

As illustrated in FIG. 3 above, a case where the rotation speed of the engine is in a range of 1,500 rpm or higher and lower than 1,700 rpm will be described. In this case, when an intake air pressure is 100 kPa, the vehicle control unit (400) sets the rising slope of the pump torque of 0% to 20% of the pump torque, as 200%/s, and sets the pump torque rising slope exceeding 20% and reaching 100%, as 80%/s.

Alternatively, when the rotation speed of the engine is in a range of 1,500 rpm or higher and lower than 1,700 rpm, and when the intake air pressure is 130 kPa, the vehicle control unit (400) sets the rising slope of the pump torque of 0% to 60% of the pump torque, as 200%/s, and sets the pump torque rising slope exceeding 60% and reaching 100%, as 80%/s.

Therefore, as illustrated in FIG. 3 above, when the rotation speed of the engine is 1,700 rpm or higher, and a pressure of the intake air volume is 130 kPa, the first inflection point may be changed from 40% to 60%.

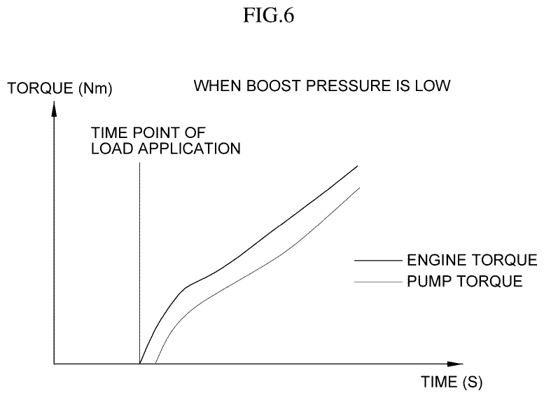

In addition, when the intake air pressure is lower than 100 kPa, the first inflection point calculated by the rotation speed of the engine belongs to 20% which is lower than 40%. Therefore, in this case, the inflection point is not changed, and is maintained at 40% to operate the pump. As illustrated in FIG. 6, when the intake air pressure is high (when it is determined that the intake air pressure increases or when the intake air pressure exceeds a section set based on a stored reference), the vehicle control unit (400) may control the pump (200) by raising the slope of the pump torque so that the pump (200) can output the calculated pump torque in accordance with the intake air volume. That is, the vehicle control unit (400) may improve the responsiveness of the work machine by identifying a load state of the engine (100), based on the intake air pressure information, and by adjusting the inflection point of the slope of the pump torque. In other words, the vehicle control unit (400) may control the pump (200) by changing the inflection point of the pump torque of the pump (200) so that the pump torque is controlled in accordance with the slope of the torque of the engine (100).

In this case, an application time point of the illustrated load may be a time point at which the vehicle control unit (400) receives a signal of the operator operating the joystick (530), and the intake air pressure supplied to the engine increases.

As an example, as illustrated in FIGS. 3 and 5, the vehicle control unit (400) may control the rising slope of the pump torque so that the first inflection point is 60% instead of 40% when the intake air pressure is 122 kPa to 130 kPa. That is, the vehicle control unit (400) may control the pump torque rising slope to maintain an initial steep rising rate until the current pump torque reaches 60%, compared to the maximum pump torque.

That is, when the intake air pressure increases, the vehicle control unit (400) may control the pump (200) to improve the responsiveness of the work machine by considering that an operation of the work machine is a continuous operation. Specifically, the vehicle control unit (400) may determine whether the current intake air pressure detected from the engine control unit (300) exceeds 100 kPa as illustrated in FIG. 5, may compare the current intake air pressure with a section set thereafter, and may determine the inflection point of the rising slope of the mapped pump torque.

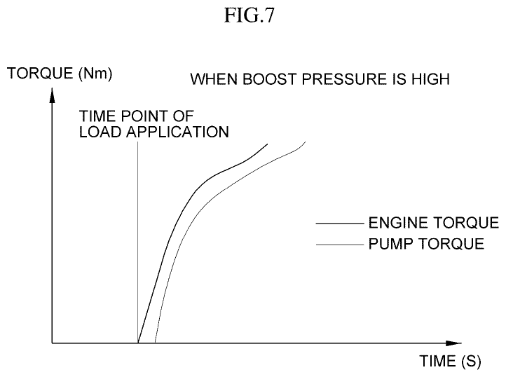

Alternatively, as illustrated in FIG. 7, the vehicle control unit (400) may control the pump (200) to reach the calculated pump torque with the slope of the preset pump torque when the intake air pressure is low (lower than a set range, based on the stored reference). In this case, it can be understood that a relatively longer time is required for the pump (200) to output the time-dependent calculated pump torque, compared to when the intake air pressure is high as described above.

That is, in FIG. 7, it can be understood that the inflection point of the slope of the pump torque in FIG. 7 is set to be lower than the inflection point of the slope of the pump torque in FIG. 6.

In addition, the construction machine (101) according to the embodiment of the present disclosure includes a regulator (700) and an electronic control valve (600) (EPPR valve).

The regulator (700) controls a swash plate of the pump (200).

The electronic control valve (600) is controlled by the vehicle control unit (400), and regulates the regulator (700). The vehicle control unit (400) may supply a set current to the electronic control valve (600) to control a set pressure. That is, the vehicle control unit (400) may variably change and supply a current provided for the electronic control valve (600) to regulate the regulator (700).

Specifically, a position of the regulator (700) may be variably changed in accordance with a secondary pressure output from the electronic control valve (600) by the current provided from the vehicle control unit (400), and may control the swash plate. That is, the regulator (700) may control the swash plate in accordance with a magnitude difference between the pressure discharged from the pump (200) and the secondary pressure output from the electronic control valve (600).

In addition, the vehicle control unit (400) according to the embodiment of the present disclosure may control the swash plate of the pump (200) by variably supplying the current to the electronic control valve (600) and controlling the regulator (700) so that the pump (200) has the calculated pump torque.

The vehicle control unit (400) may control the swash plate of the pump (200) so that the pump (200) has the calculated maximum torque in accordance with the intake air pressure information, based on slope information of the pump torque mapped according to the previously stored intake air pressure information, and may change settings of the pump torque rising slope.

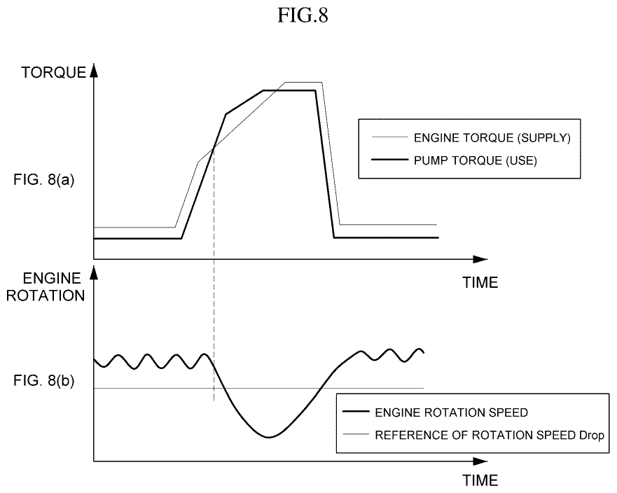

As illustrated in FIG. 8(a) and 8(b), the time-dependent change rate of the pump torque, the change rate of the engine torque, and the change rate of the rotation speed of the engine at that time are illustrated.

In a section where the engine torque exceeds the pump torque, there is a problem in that the rotation speed of the engine decreases and falls below a reference of a rotation speed drop of the engine. Specifically, a section illustrated by a dotted line in FIG. 8(a) and 8(b) in which the pump torque exceeds the engine torque indicates a section in which the rotation speed of the engine rapidly decreases. That is, the rotation speed of the engine falls below the reference of the Drop, and output efficiency of the engine decreases, compared to the supplied fuel.

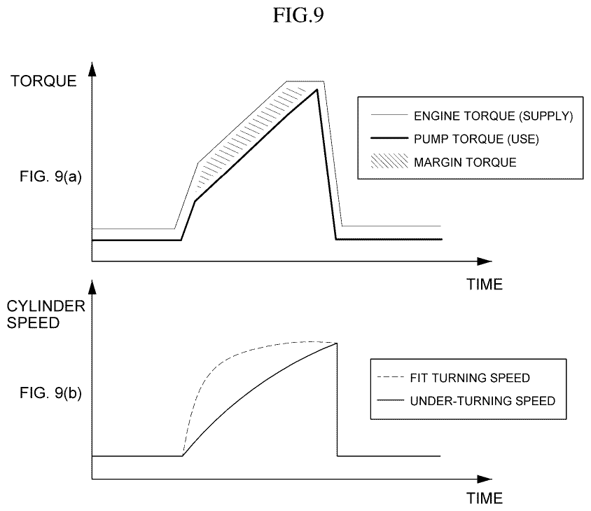

In addition, as illustrated in FIG. 9(a) and 9(b), the change rate of the pump torque, the change rate of the engine torque, and the change rate of the cylinder speed at this time are illustrated.

As illustrated in FIG. 9(a) and 9(b), in a section in which the pump torque exceeds the engine torque, a margin torque is generated, compared to a torque which can be output from the pump in terms of performance.

In this case, as illustrated by a solid line, the cylinder speed of the pump indicates the change rate which is lower than a pit turning speed at which the pump can be operated at a under-turning speed. That is, the cylinder speed of the pump indicates a state where the pump is not operated at a cylinder speed which enables a maximum operation.

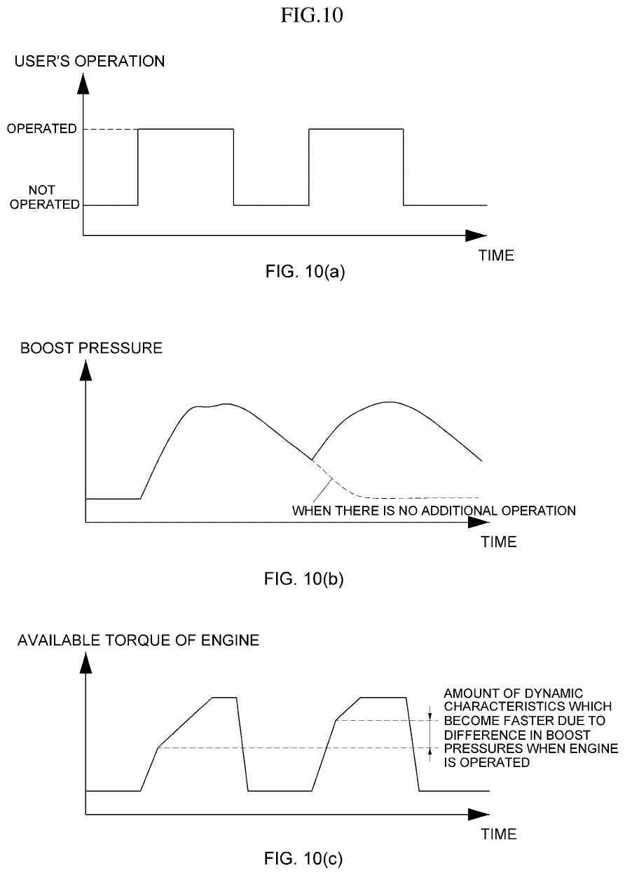

As illustrated in FIG. 10(a) to 10(c), formation of a boost pressure and a behavior of an available torque of the engine according to a user's operation are illustrated.

A time-dependent operation status of the joystick operated by the user, the boost pressure, and the available torque of the engine are illustrated in a time-dependent manner.

When the boost pressure is indicated by a dotted line, a case where there is no additional operation of the construction machine since the user does not operate the joystick is illustrated. That is, when a continuous operation of the user operating the joystick is performed again after the joystick is operated, through a graph of the time-dependent boost pressure and the user's operation in FIG. 10, it can be understood that the boost pressure maintains a relatively higher state, compared to when there is no additional operation.

The operation signal of the user may be used to determine whether there is an operation or whether there is no operation. However, there is a problem in that the vehicle control unit (400) is less likely to determine information when an operation is terminated and immediately the operation is continued.

In view of the time-dependent change rate of the available torque of the engine over time, it can be understood that a starting point of the available torque of the engine is changed due to a difference in the boost pressures when the continuous operation is performed.

Specifically, when the continuous operation is performed, it can be understood that the starting point of the available torque of the engine is relatively higher than the starting point of the initial operation. The boost pressure is relatively higher when the continuous operation is performed, compared to when the initial operation is performed. Therefore, it can be understood that dynamic characteristics of the engine become faster since this boost pressure is supplied to the engine.

In a case of the available torque of the engine, when the continuous operation of the construction machine is performed, the dynamic characteristics of the torque become faster, and the inflection point of the slope of the engine torque passes in a different manner, and there is a problem in that the pump is controlled while the slope of the pump torque and the inflection point are maintained.

Based on this information, the construction machine (101) according to the embodiment of the present disclosure may control the pump (200) by utilizing the boost pressure information.

Specifically, the vehicle control unit (400) according to the embodiment of the present disclosure may recognize the continuous operation of the construction machine (101) through the boost pressure instead of recognizing the continuous operation of the construction machine (101) through a user's operation signal. Therefore, it can be understood that this determination is much more advantageous. That is, the pump torque may be controlled by calculating a line of the available torque of the engine, based on the information on the boost pressure at each moment.

In other words, the construction machine (101) of the present disclosure may control the pump (200) by variably changing the inflection point of the slope of the pump torque in view of the dynamic characteristics of the engine which become faster due to the relatively increased boost pressure when the continuous operation is performed.

The upper drawing 11(a) in FIG. 11 illustrates a general construction machine, and the lower drawing illustrates the construction machine of the present disclosure.

As illustrated in the upper drawing, there is a difference due to a time-dependent change in the pump torque and the engine torque. Accordingly, it can be understood from this difference that there is an unused torque.

That is, it can be understood that a gap region between the engine torque and the pump torque is an unused torque section where the pump is not used to maximum performance.

However, the construction machine (101) of the present disclosure may control the pump by changing the slope of the pump torque having the inflection point according to the preset rotation speed of the engine to the inflection point of the slope of the pump torque mapped based on the information on the intake air volume of the engine. Therefore, the pump may be effectively used by reducing the gap region between the engine torque and the pump torque, compared to the related art.

Specifically, as illustrated in the lower drawing 11(b) in FIG. 11, the construction machine (101) of the present disclosure may control the pump by raising the inflection point of the slope of the pump torque, based on the booster pressure. Therefore, the gap region between the engine torque and the pump torque may be reduced, compared to the related art.

That is, as illustrated in FIG. 10 above, the construction machine (101) of the present disclosure may effectively control the pump (200) so that the increased dynamic characteristics of the engine (100) due to an increase in the booster pressure correspond to the changed dynamic characteristics of the engine (100), based on the booster pressure information.

Therefore, the construction machine (101) according to the embodiment of the present disclosure may control the engine and the pump to be operated at maximum performance by variably setting the slope of the pump torque to match the slope of the engine torque. That is, the construction machine (101) of the present disclosure may effectively utilize the performance of the pump by controlling the dynamic characteristics of the pump to correspond to the dynamic characteristics of the engine.

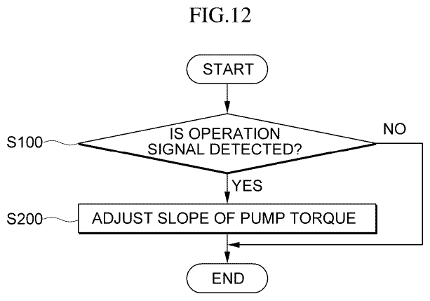

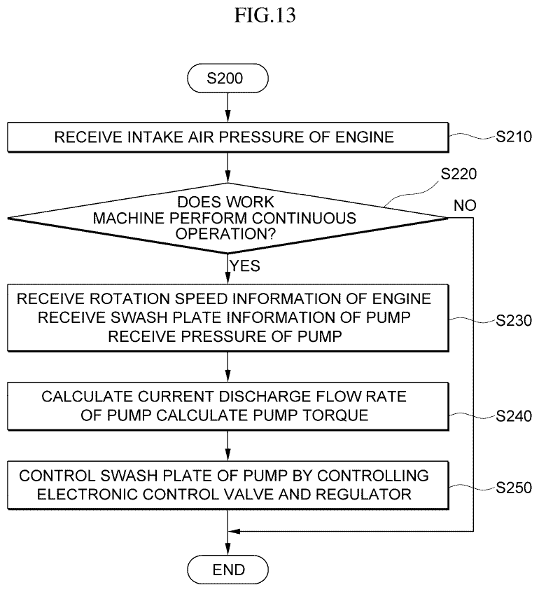

Hereinafter, with reference to FIGS. 1 to 13, a control process of the construction machine (101) according to the embodiment of the present disclosure will be described.

The vehicle control unit (400) receives the operation signal from the joystick (530), and determines whether the joystick (530) is currently operated by the user's operation (S100). That is, the vehicle control unit (400) determines whether the user operates the construction machine (101) to carry out work, through operation signal information of the joystick (530). That is, the vehicle control unit (400) receives the operation signal of the joystick (530) for operating the work machine, and determines a work operation of the construction machine (101).

The vehicle control unit (400) controls the slope of the pump torque (S200). That is, the vehicle control unit (400) may control the pump (200) by changing the inflection point of the slope of the pump torque. When the vehicle control unit (400) receives the operation signal of the joystick (530), the vehicle control unit (400) may control a rising change rate of the pump torque of the pump (200).

Specifically, the vehicle control unit (400) receives the information on the intake air volume (intake air pressure information or boost pressure information) of the engine (100) (S210). The vehicle control unit (400) receives information on a current intake air volume of the engine (100) which is detected by the engine control unit (300).

After the operation signal is transmitted from the joystick (530), the vehicle control unit (400) receives the information on the intake air volume of the engine (100) and determines the continuous operation of the work machine of the construction machine (101) (S220). Specifically, the vehicle control unit (400) compares the information on the current intake air volume with the preset intake air volume and determines that the work machine currently performs the continuous operation when the information on the current intake air volume exceeds the preset intake air volume.

Specifically, when the operation signal of the joystick (530) is detected, and the information on the intake air volume of the engine exceeds a preset value, the vehicle control unit (400) may determine that the work machine performs the continuous operation and may control the pump (200) to improve the responsiveness.

When the vehicle control unit (400) determines that the work machine performs the continuous operation, the vehicle control unit (400) receives the rotation speed information of the engine (100), the swash plate information of the pump (200), and the pressure information of the pump (200) (S230).

In addition, the vehicle control unit (400) calculates the current discharge flow rate of the pump (200), based on the received rotation speed information of the engine and the received swash plate information, and calculates the pump torque, based on the calculated current discharge flow rate of the pump and the received pressure of the pump (S240). In addition, the vehicle control unit (400) variably changes and provides a current to be transmitted to the electronic control valve (600) so that the pump (200) has the calculated pump torque (S250). That is, the swash plate of the pump (200) is controlled by the electronic control valve (600).

That is, the vehicle control unit (400) adjusts the rising change rate of the pump torque by changing the inflection point of the slope of the pump torque mapped according to the preset information on the intake air volume of the engine (S200). In this case, the vehicle control unit (400) may control the pump (200) to quickly reach the calculated maximum pump torque. In other words, the vehicle control unit (400) may change an increase rate of the pump torque of the pump, based on the intake air volume and the rotation speed of the engine, and may control the pump (200) to quickly reach the maximum pump torque.

The vehicle control unit (400) changes the inflection point of the slope of the pump torque having the inflection point preset according to the rotation speed of the engine (100) to the inflection point of the slope of the pump torque mapped according to the information on the intake air volume of the engine, and controls the rising change rate of the pump torque (increase rate of the pump torque) (S200).

That is, the vehicle control unit (400) controls the pump (200) by raising the slope to the slope of the pump torque mapped according to the information on the intake air volume (intake air pressure, booster pressure) of the engine (100). In this manner, the vehicle control unit (400) may control the pump (200) on a real-time basis so that the work machine has a fast responsiveness.

According to this configuration, the construction machine (101) according to the embodiment of the present disclosure may use the information on the intake air volume in which the slope of the pump torque for the dynamic characteristics of the engine in the related art is supplied to the engine, and may control the pump by variably changing the slope of the pump torque. Therefore, work performance of equipment may be improved according to work environment conditions.

In addition, the construction machine (101) according to the embodiment of the present disclosure may improve the responsiveness of the work machine at an initial stage of the operation of the work machine. Therefore, work productivity may be improved by using the construction machine (101).

Although the embodiments of the present disclosure have been described with reference to the accompanying drawings, those skilled in the art to which the present disclosure pertains may understand that the present disclosure may be embodied in other specific forms without changing a technical idea or essential characteristics thereof.

Therefore, it should be understood that the embodiments described above are provided as examples and do not include a limitation in all respects. As the scope of the present disclosure, the detailed description above is indicated by the appended claims to be described later, and it should be interpreted that all changes or modifications derived from the meaning and the scope of the appended claims and equivalents thereof are included in the scope of the present disclosure.

### INDUSTRIAL APPLICABILITY

A construction machine and a control method thereof according to an embodiment of the present disclosure can improve a responsiveness of a work machine by changing a slope of a pump torque to operate a pump.

What is claimed is:

1. A construction machine comprising:
an engine that generates power;
a pump driven by the engine;
an engine control unit that detects an intake air volume of the engine;
a joystick that transmits an operation signal; and
a vehicle control unit that receives the intake air volume detected by the engine control unit when the operation signal is transmitted from the joystick, and that upwardly changes an increase rate of a pump torque when the intake air volume is at a certain level.

2. The construction machine of claim 1, wherein the increase rate of the pump torque is upwardly changed so that a maintenance period of a slope of an initial rising section increases, based on the intake air volume.

3. The construction machine of claim 2, wherein the engine control unit detects rotation speed information of the engine and transmits the rotation speed information to the vehicle control unit, and the vehicle control unit changes a rising slope of the pump torque after the initial rising section, based on the rotation speed information of the engine.

4. The construction machine of claim 1, wherein the engine control unit detects rotation speed information of the engine and transmits the rotation speed information to the vehicle control unit, and the vehicle control unit upwardly changes the increase rate of the pump torque, based on the rotation speed information of the engine.

5. The construction machine of claim 1, further comprising:
a pump pressure detection member that detects a pressure of the pump, wherein the vehicle control unit calculates the pump torque, based on a current discharge flow rate and the pressure of the pump.

6. The construction machine of claim 5, further comprising:
a swash plate detection member that detects swash plate information of the pump, wherein the vehicle control unit calculates the current discharge flow rate of the pump, based on the rotation speed information of the engine and the swash plate information.

7. The construction machine of claim 1, wherein the vehicle control unit has a slope map in which an inflection point of a slope of the pump torque is set, and the inflection point is changed in accordance with information on the intake air volume.

8. A construction machine comprising:
an engine that generates power;
a pump driven by the engine;
an engine control unit that detects information on an intake air volume of the engine and a rotation speed of the engine;
a joystick that operates a work machine; and
a vehicle control unit that determines a continuous operation of the construction machine, based on the information on the intake air volume of the engine, when an operation signal is transmitted from the joystick, and that upwardly changes an increase rate of a pump torque of the pump, based on the intake air volume and a rotation speed of the engine.

9. The construction machine of claim 8, wherein the increase rate of the pump torque is upwardly changed so that a maintenance period of a slope of an initial information of the engine.

10. A control method of a construction machine including a vehicle control unit for controlling a pump driven by an engine, the control method comprising:
a step of receiving an operation signal of a joystick;
a step of receiving intake air pressure information of the engine and rotation speed information of the engine; and
a step of controlling the pump by changing a slope of a pump torque having an inflection point according to a preset rotation speed of the engine to an inflection point of the slope of the pump torque mapped based on the intake air pressure information of the engine.

11. The control method of a construction machine of claim 10, further comprising:
a step of receiving the rotation speed information of the engine and pressure information of the pump, calculating a current discharge flow rate of the pump, and calculating the pump torque, based on the calculated current discharge flow rate of the pump and the received pressure information of the pump.

12. The control method of a construction machine of claim 10, further comprising:
a step of determining a continuous operation of a work machine, when the intake air pressure information exceeds a preset range after an operation signal of the joystick is received.
